(19) United States
(12) Patent Application Publication
(10) Pub. No.: US 2011/0212296 A1
(43) Pub. Date: Sep. 1, 2011

(54) Coating Structure

(75) Inventor: Volkmar Eigenbrod, Krefeld (DE)

(73) Assignee: Rhenotherm Kunststoffbeschichtungs GmbH

(21) Appl. No.: 12/902,701

(22) Filed: Oct. 12, 2010

(30) Foreign Application Priority Data
Oct. 12, 2009 (DE) 102009049137.6

(51) Int. Cl. B32B 3/00; B05D 1/36; B05D 3/12; B05D 1/32

(52) U.S. Cl. 428/141; 427/402; 427/355; 427/448

(57) ABSTRACT

The invention relates to a non-stick coating for a surface of a substrate. In order to significantly improve the non-stick properties compared to the previously known surface coatings and to ensure adequate stability, the surface coating contains at least one fluoropolymer and is characterised by a layer structure with at least one microstructured first layer and at least one submicrostructured second layer overlaying the latter. The invention also relates to a method for producing a surface coating of this type, in which the microstructured subsurface is produced by applying a microstructured layer to a macrostructured surface.

### TECHNICAL AREA

The invention relates to a non-stick coating for a surface of a substrate, which contains at least one fluoropolymer, and a method for the production thereof.

### PRIOR ART

A non-stick coating in the framework of the present invention is taken to mean a layer structure which is such that it is particularly suitable for rollers or other machine parts in the adhesive, rubber or paint-processing industry. Good non-stick properties are particularly relevant where specific surface regions, for example of labels, adhesive tapes, nappies and other products are to have the property that adhesive or other sticky media do not adhere there. Deliberately limited adhesive regions can thus be created while the neighbouring regions are incapable of adhesion, i.e., the adhesive or other sticky media can be mechanically applied deliberately and in a locally limited manner. The correspondingly coated tools, such as, for example rollers in the paper industry to produce multi-layer or laminated paper, remain adhesive-free.

In 1997, Barthlott and Neinhuis described the so-called lotus effect with the title “Purity of sacred lotus or escape from contamination in biological surfaces” in Planta 202 No. 1, pages 1 to 8, in nature, water-repelling surfaces such as the leaves of lotus plants are to be found with a water contact angle of 165°. These have a hierarchical structure such that at least one set of two different roughness structures is present, in the lotus plant, this is a microscaled structure, the so-called papillae, which is coated by a nanoscaled structure of colloidal wax crystals. This configuration ensures that water drops, when rolling off, pick up dirt particles and transport them away. This ensures that the surface of the leaf of the lotus plant is always kept clean.

This effect is also used industrially. Materials with a surface structure are known, in which the structure of the lotus leaf is imitated, in this case, silicone is used as the surface material and can be processed or treated such that a type of “double structure” is produced on the surface. The surface consists of a stud-like microstructure, the individual studs in turn having nanoelevations.

The drawback is that the surfaces coated in this manner with silicone have no resistance to solvents and corrosion. Furthermore, these surfaces are not authorised for food applications. Finally a corresponding surface is out of the question because of the material property of the silicone for many applications. In painting applications (for example in car painting) a surface coated in this manner is unsuitable as the paint is repelled by the silicone and so-called “fish eyes” occur. A drawback is finally that the hardness of the surface is relatively low.

On the other hand, surface coatings using fluoroplastics (for example Teflon) are known, which lead to a harder surface. The fluoroplastic is sintered in on a carrier layer here at elevated temperatures (about 400° C.) in order to obtain a stable bond. However, owing to the flowing of the fluoropolymer in the course of the sintering process, the basic structure of the substrate is levelled; a lotus effect cannot be obtained in this manner.

A heat exchanger is disclosed in EP 0 485 801 81, which has a large number of plate-shaped ribs. Applied to the rib surface is a mixture consisting of a solution, which contains a silicone resin compound, and finely distributed inorganic particles. Silicone is used here as the base layer. It is furthermore provided that the surface of the layer has regularly distributed micro-elevations.

DE 35 44 211 A1 discloses a method for producing a sole of an iron. Owing to the sequence of various method steps, a metallic carrier substrate is provided with a low-adhesion plastics material surface, which is as smooth as possible and sealed. A binder of an organic type is used for the sealing.

DE 198 33 375 A1 describes an item, which consists of metal, ceramic, enamel or glass and is provided with an at least one-layer coating, which has inorganic and/or organic pigment, fluoropolymer and at least one type of polyamide imides, polyimides, polyetherimides and similar substances as the binding resin. The specification of the coating is specified here both with regard to the quantities of the components and also with regard to their particle size.

A method is known from WO 01/49424 A2, in which a layer of a plastics material is applied to a substrate with a structured surface, the surface of the layer being provided with a large number of substantially regularly distributed micro-elevations, in that components in a quantity of 10 to 30% by weight and with a grain size of 2 to 200 μm are added to the plastics material before application to the substrate. A water contact angle of 128 is disclosed for an exemplary surface produced by this method.

### PRESENTATION OF THE INVENTION

One object of the invention is to provide surface coatings, which have the lotus effect, the non-stick properties of which are clearly improved compared to the previously known surface coatings and which are adequately mechanically stable. A method is also to be provided by the present invention for producing a surface coating of this type.

This object is achieved by a non-stick coating with the features of claim 1 and a method for producing a non-stick coating with the features of claim 5.

Substrates are taken to mean here and below, in particular those which at least partially consist of metal, ceramic, glass, enamel or a composite material of these, but also those made of other suitable materials. Materials are particularly suitable as a component of a substrate if they are adequately thermally stable during an optionally provided sintering process.

A non-adhesive plastics material is taken to mean, here and below, in particular a fluoropolymer such as, for example, polytetrafluoroethylene (PTFE), perfluoroalkoxy alkane (PFA), perfluoroethylene propylene copolymer (FEP) but also other suitable materials, which contain perfluorinated carbon chains and have comparable hydrophobic properties.

microstructured subsurface is taken to mean, here and below, one with roughness in the micrometre range, in particular in the range of 2 to 50 μm RA. The subsurface can be formed by the substrate itself, but also by a layer applied or laid on the substrate.

A hierarchical layer structure is taken to mean one in which a second surface structure of a second layer is overlaid on a first layer with a first surface structure, without the first surface structure being levelled in the process.

A first microstructured layer of the hierarchical layer structure is taken to mean one with micro-elevations in the range of 2 to 50 μm, and a submicrostructured second layer, which overlays the first, is taken to mean one with elevations in particular in a range of 0.1 to 5 μm, the elevations of which are smaller than the elevations of the first microstructured layer.

In a preferred configuration of the non-stick coating according to the invention, the first microstructured layer contains an addition of 6 to 30% by weight of organic and/or inorganic particles, particular of polyphenylene sulfone (PPSO₂) or silicon carbide (SiC) in order to produce an additional structuring of the layer. The particle size of the additional materials and the degree of filling can be varied in accordance with the desired effect. For example, good results are achieved with PPSO₂ additions with an average particle diameter of 20 μm.

The non-stick coating according to the invention is distinguished by a water contact angle CA>=150°, in particular in conjunction with a water contact angle hysteresis CAH<=8° and/or a run-off angle <=10°. Water contact angles of >=165° with a hysteresis and a run-off angle approaching zero are possible with the non-stick coating according to the invention. Thus the removal force of a Tesa@ tape from a surface coated with the non-stick coating according to the invention can approach zero.

To produce a non-stick coating according to the invention, the microstructured subsurface is preferably produced by the application of a microstructured layer to a macrostructured surface. The surface of the substrate may in this case already itself have a macrostructure if it has a corresponding roughness. The macrostructure may, however, also be provided by the type of substrate, such as, for example, in the case of a fine wire woven fabric. A suitable macrostructure of the substrate surface can also be produced, for example by sand blasting or else by applying and fastening a macrostructured lattice fabric. In addition and/or as an alternative to this, a macrostructured surface can be produced by thermal spraying on of a macrostructured layer onto the substrate, in particular by flame spraying a metal wire or metal powder, such as, for example, chromium/nickel wire or melted chromium/nickel powder.

The microstructured layer of the microstructured subsurface is produced on the macrostructured surface, preferably by the application of oxide ceramics, in particular titanium oxide (TiO₂) and/or aluminium oxide (Al₂O₃), particularly preferably by thermal spraying.

Alternatively, the microstructured layer of the microstructured subsurface can also be applied to a microstructured substrate surface, the structure of which is preferably produced by sand blasting, the roughness of the surface, as in the production of a macrostructured substrate surface, being able to be influenced by the grain size of the selected corundum (from fine corundum through to coarse corundum).

In a preferred configuration of the method according to the invention at least a first microstructured layer is produced on the microstructured subsurface, in that a powder containing at least one fluoropolymer with a grain size in the range of 500 nm to 30 μm is applied, the powder preferably being heated after application precisely such that the powder grains start to melt on the subsurface and connect thereto, but substantially retain their shape. This prevents valleys and cavities being produced by the microstructure of the subsurface being clogged by the microstructured fluoropolymer layer.

The microstructured layer is additionally structured by fillers in the microstructured fluoropolymer layer. It is advantageous here if the powder contains an admixture of inorganic particles such as, in particular, of SiC or Al₂SO₃ and/or organic particles such as polyamides or PPSO₂, or mixtures thereof, preferably at a fraction of 5 to 30% by weight. The particles ensure an improved microstructure and simultaneously an adequate mechanical stability of the coating.

The first microstructured fluoropolymer layer is preferably applied in coating thicknesses of 5 to 15 μm per application. A multiple application is possible and sensible and a preferred layer thickness is 20 μm to 50 μm.

The second submicrostructured layer, which preferably has a nanostructure, the elevations of which are smaller than 1 μm, is preferably produced by application of finely dispersed fluoropolymer with a grain size of 90 to 300 nm on the microstructured first fluoropolymer layer. Also when stoving this second layer, it is advantageous if the coating is heated precisely such that the particles of the second layer merely start to melt, so that they connect to the layer located there below but substantially retain their shape.

In a still further configuration of the method according to the invention, the finely dispersed fluoropolymer contains an addition of whiskers, in particular of potassium titanate whiskers, and/or of carbon nanotubes, preferably with a fraction of 5 to 40% by weight, in particular in relation to potassium titanate whiskers more preferably with a fraction of 10 to 40% by weight. As a result, a surface structure with whiskers or tubes forms, with which the greatest water contact angles can be achieved.

Finally, a primer layer, the thickness of which preferably does not exceed 5 μm and does not fall below 1 μm, can be provided between the hierarchical layer structure of the at and second layer and the microstructured subsurface. Better adhesion of the fluoropolymer on the subsurface and therefore an increased mechanical stability of the non-stick coating can thereby be achieved.

### METHODS FOR CARRYING OUT THE INVENTION

The method according to the invention and the coating according to the invention will be described below with the aid of various preferred exemplary embodiments.

In the drawings

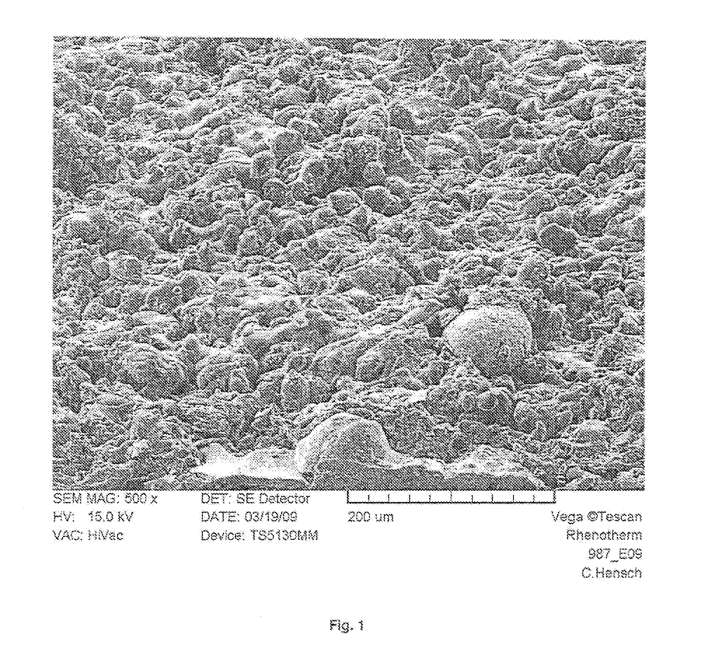

FIG. 1 shows a scanning electron microscope picture of as coated surface according to the invention with an inorganic microstructure;

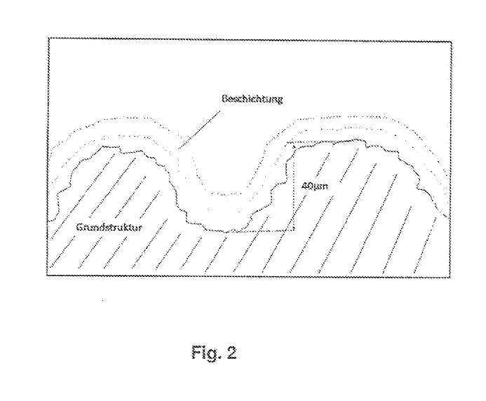

FIG. 2 shows a sketched coating structure with a base structure and a first, multi-layer applied fluoropolymer layer;

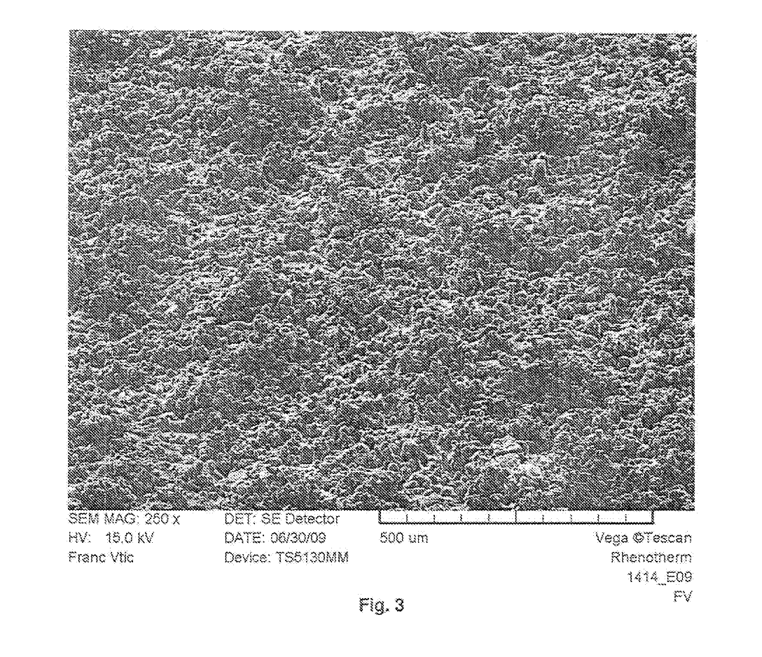

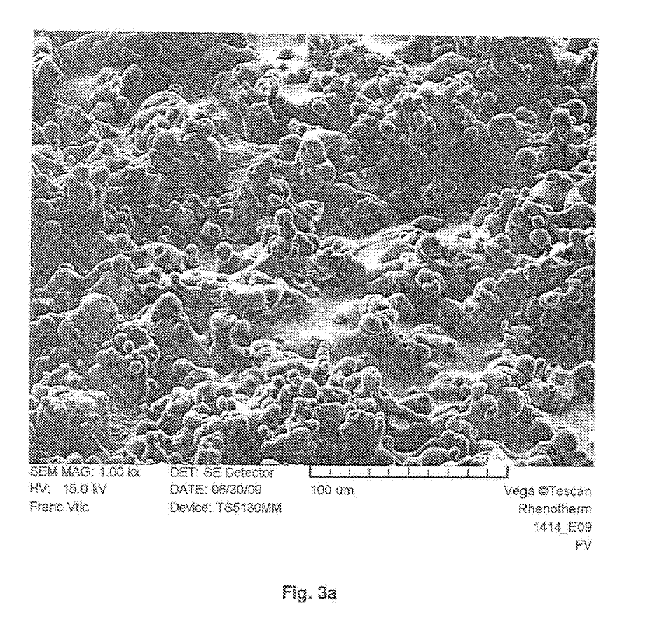

FIGS. 3 and 3a show scanning electron microscope pictures of a further coated surface according to the invention with a cluster structure in different resolutions;

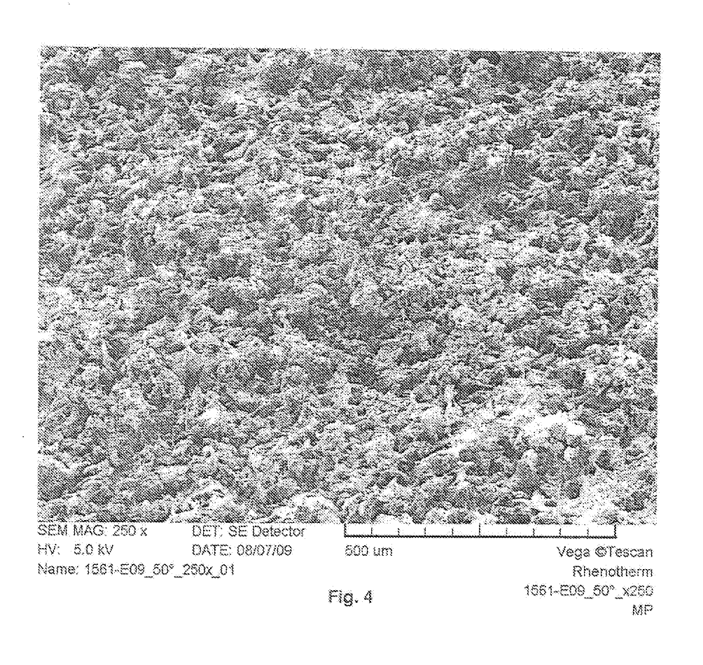

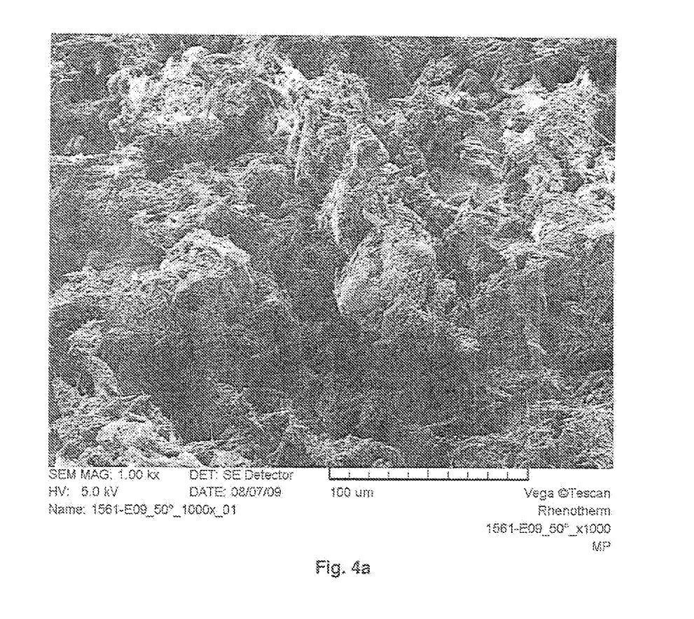

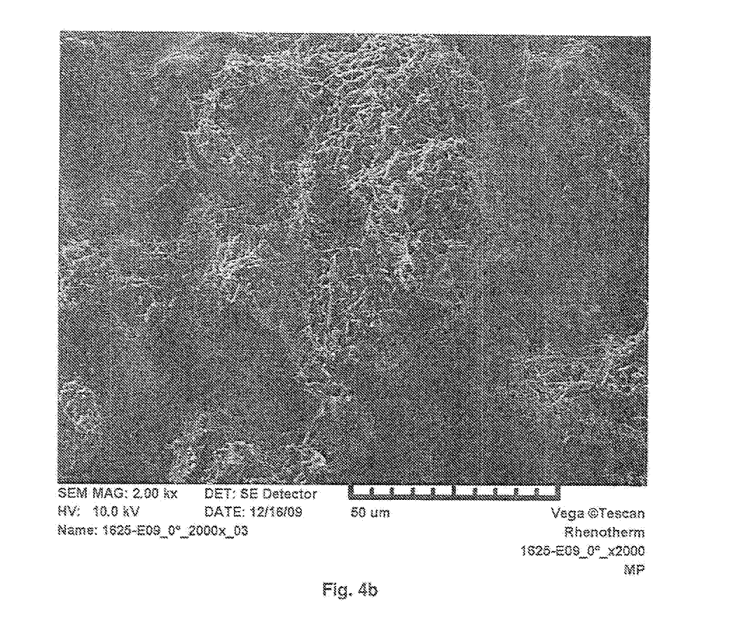

FIGS. 4, 4a and 4b show scanning electron microscope pictures of another coated surface according to the invention with a whisker structure (FIGS. 4 and 4a with potassium titanate whiskers, FIG. 4b with carbon nanotubes) in different resolutions;

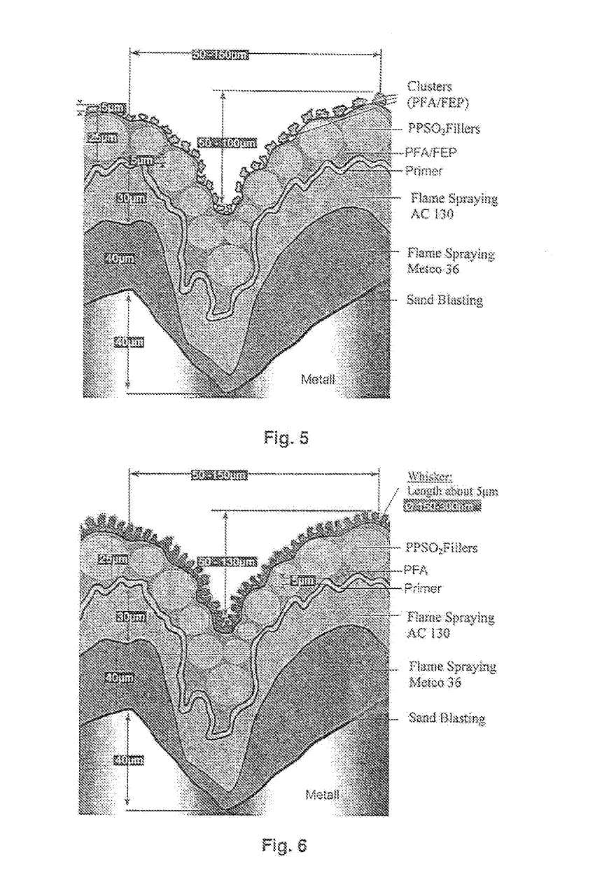

FIG. 5 shows a schematic view of a coated surface according to the invention with a high-grade steel substrate with a cluster structure;

FIG. 6 shows a further schematic view of a coated surface according to the invention on a high-grade steel substrate with a whisker structure;

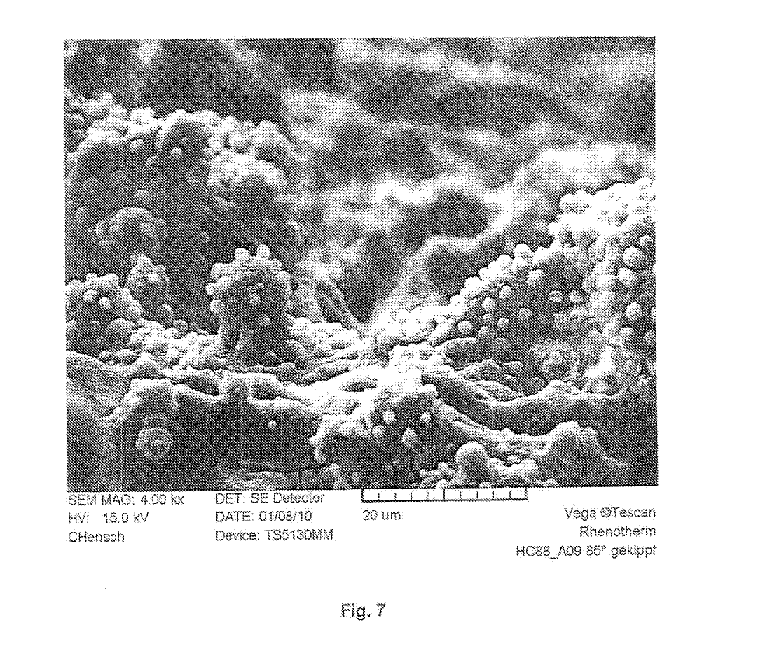

FIG. 7 shows a scanning electron microscope picture of another coated surface according to the invention with a rose structure; and

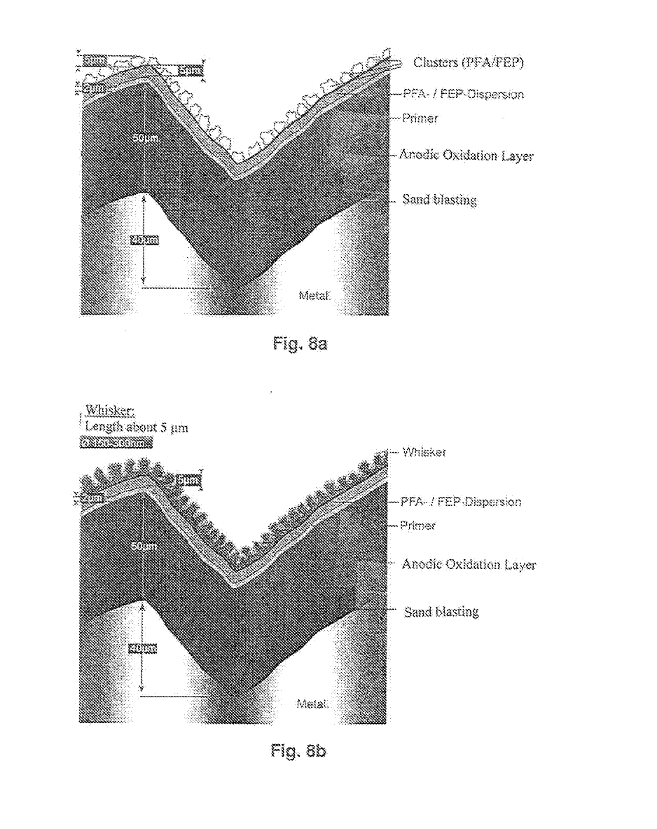

FIGS. 8a and 8a show further schematic views of coated surfaces according to the invention on an aluminium substrate (FIG. 8a with a cluster structure and FIG. 8b with a whisker structure).

As already mentioned at the outset, the hierarchical layer structure is applied to a microstructured subsurface. This microstructured subsurface can already be provided by the substrate surface, but is generally produced by a treatment and/or coating of the substrate surface, in particular by producing a hard base layer.

To produce a hard base layer on a metallic substrate, the surfaces of an aluminium body, a high-grade steel body and a normal steel body, once they had been degreased, were firstly sand blasted with coarse corundum (Al₂O₃). The surfaces were freed from any oxide layers and other contaminations by the sand blasting. Moreover, the surfaces received a first structure, which allows a subsequent coating, which is, for example, applied as described below by thermal spraying, to undergo a mechanical interlocking with the body surface.

The roughness values measured by a touch measuring device from the company Mahr for surfaces sand blasted with coarse corundum, based on a measuring distance of 5.6 mm with a limit wavelength of 0.8 m, can be inferred from the blowing Table 1.

TABLE 1

| | Coarse corundum | Coarse corundum | Coarse corundum |
|---|---|---|---|
| | blasting onto | blasting onto high- | blasting onto normal |
| | aluminium | grade steel | steel |
| Rₐ (μm) | 5.67 | 2.78 | 4.53 |
| R_{z} (μm) | 35.43 | 17.45 | 29.47 |
| Rₘₐₓ (μm) | 43.48 | 20.59 | 32.06 |
| R_{Sk} | −0.53 | 0.24 | 0.19 |
| R_{Ku} | 3.82 | 3.06 | 3.11 |

After the sand blasting, the surfaces were flame sprayed with Metco® 36C, a tungsten carbide-containing nickel-chromium alloy powder. As a result, the surface receives a macrostructure, which is independent of the surface structure of the substrate. The roughness values measured with the touch measuring device of the flame-sprayed surface are reproduced in Table 2 (measuring distance: 5.6 mm, limit wavelength: 0.8 mm).

TABLE 2

| | |
|---|---|
| Rₐ (μm) | 5.69 |
| R_{z} (μm) | 41.94 |
| Rₘₐₓ (μm) | 62.28 |
| R_{Sk} | −0.11 |
| R_{Ku} | 4.33 |

In an alternative coating, the surfaces were flame sprayed with a ceramic powder of the type AC130 (Metco 130) from the company Sulzer-Metco. As a result, a finer surface structure is produced which is already produced from the particle size of the powder, which is in the range of 5 to 30 μm. The roughness values of the surface being produced from this are reproduced in Table 3.

The roughness is constructed according to the Gaussian normal distribution and very uniformly in accordance with the method.

TABLE 3

| | |
|---|---|
| Rₐ (μm) | 5.08 |
| R_{z} (μm) | 31.99 |
| Rₘₐₓ (μm) | 46.58 |
| R_{Sk} | 0.37 |
| R_{Ku} | 3.96 |

An overlaying of the two flame spraying systems in which Metco 36C was firstly applied followed by the ceramic powder Metco 130 by flame spraying, leads to a hierarchical structure to be established with an overall layer thickness of 50 μm to 150 μm.

The roughness values reflected in Table 4 were measured for the surface being produced from this. The surface structure is reproduced in FIG. 1 as a picture. The roughness value at 6.59 is very pronounced. The roughness distribution is beautifully uniform. Thus Rₘₐₓ at 39.23 does not deviate strongly from R_{z}=36.64 and the R_{Sk} value at −0.09 is in the advantageous range, likewise R_{Ku} at 2.43 is close to the Gaussian distribution.

TABLE 4

| | |
|---|---|
| Rₐ (μm) | 6.59 |
| R_{z} (μm) | 36.64 |
| Rₘₐₓ (μm) | 39.23 |
| R_{Sk} | −0.09 |
| R_{Ku} | 2.43 |

The described method for producing a hard base layer is as preferred method but other methods can also be used if a comparable microstructured layer is produced with it.

A hydrophobic layer structure. Was then applied to the presently produced, microstructured subsurface. The fluoropolymers PTFE, PFA and also FEP were used for coating. All three materials are fully fluorinated plastics materials, which differ with regard to a few properties such as, for example, the melting point.

The important properties of the fluoropolymers used and other, basically usable hydrophobic coating materials are shown in Table 5.

TABLE 5

| | | | | | Surface free | | |
|---|---|---|---|---|---|---|---|
| | | | | | energy (SFE) | | |
| | | Contact | | | according to Wu | | |
| | | angle | Roll-off | | | Dispersed | Polar |
| | Melting point | Tangent 1 | angle | Hysteresis | Total | part | part |
| Material | [° C. ] | [°] | [°] | [°] | [mN/m] | [mN/m] | [mN/m] |
| PTFE | 323 | 114 | 34 | 35.1 | 21.8 | 22.2 | −0.4 |
| PFA | 310 | 110 | 20 | 21.5 | 16.7 | 14.3 | 2.4 |
| FEP | 270 | 104 | 16 | 6.6 | 20 | 13.9 | 6.1 |
| Silicone | | 111 | 40 | 41 | 19.4 | 16.7 | 2.7 |
| Sol gel | | 98 | 19 | 21.4 | 24.1 | 16.6 | 7.5 |

To apply a first microstructured fluoropolymer layer, it was regarded as important to retain the microstructure of the subsurface. In order to ensure this, the fluoropolymer was applied as a powder, specifically by electrostatic coating. The coating took place in a plurality of processes to a layer of thickness of 20 μm to 50 μm. The powder layers follow after the application of the contour of the base structure.

After the application of the fluoropolymers, these were sintered, i.e. they were brought to above their melting point in order to achieve melting. The temperature during sintering is generally at least 20° C. mostly generally at least over 50° C. above the melting point.

In order to increase the melt viscosity, so the structure of the subsurface is not levelled and to simultaneously give the coating its own structure, an addition of 5% PPSO₂, 5% SiC or 20% PPSO₂ was added to the fluoropolymer powder used for coating. Of the basically suitable organic additives, PPSO₂ is particularly suitable because of its high melting point, which is above 400° C. The PPSO₂ used had a mean diameter of 20 μm.

During melting, i.e. sintering of the layer, the viscosity of the melt was so high that it could not flow away into the valleys of the microstructured subsurface. The layer structure being produced is shown in FIG. 2.

With the selection of the fluoropolymers used, their fillers and the selected layer thickness, a microstructured first layer with already very good use properties was achieved, namely with a high mechanical stability, easy applicability to substrates of the most varied sizes and geometries and good non-stick properties

In a sample with a hierarchically constructed, inorganic hard base structure made of Metco 36C and Metco 130, which was coated with a PFA fluoropolymer with an addition of 5% PPSO₂, a water contact angle of 140° and a run-off angle of 12° were measured. In a sample with the same hard base structure, which was coated with a PEA fluoropolymer powder with an addition of 5% SiC, a water contact angle of 144° and a run-off angle of 12° were measured. In a further sample with the same, hierarchically constructed hard base structure, which was coated with a PEA fluoropolymer powder with an addition of 90% PPSO₂, a water contact angle of 156° and a roll-off angle of 21 were measured.

A fluoropolymer dispersion was then sprayed onto a sample with a hierarchically constructed hard base structure made of Metco 36C and Metco 130, which was applied in the above-described manner and onto which one microstructured first layer made of a PEA, fluoropolymer powder with 20% PPSO₂ addition was applied. By means of a high atomisation during the spraying on of the dispersion with a grain size of 90 nm to 150 nm at a surface temperature of the first microstructured layer of 100° C. and by subsequent sintering of the layer at a temperature of 360° C. for a period of 10 minutes, it was achieved that firmly fused particles with a size of about 500 nm to 5 μm form on the surface. These so-called clusters are firmly fused to the fluoropolymer located there below. As a result they are noticeably stable and cannot be removed by an adhesive tape removal test, a so-caned 90° peel test, in which a Tesa® adhesive tape (Tesa test tape for testing surfaces No. 07475) is applied to the surface and then removed again. The water contact angle of the surface thus produced was 165 and the run-off angle was 5°.

The microstructures thus achieved have a diameter of about 25 μm and a height of about 20 μm. In other test samples, microstructures with a diameter of about 25 μm and a height up to 100 μm were achieved. The spacings of the elevations are about 30 to 50 μm and may be about 100 μm. The submicrostructures formed by the clusters are about 2 to 5 μm in height and about 10 to 15 μm in length. Scanning electron microscope pictures of the surface can be seen in FIG. 3 (250 times magnification) and FIG. 3a (1000 times magnification).

Substantially the same results were achieved when using FEP as the fluoropolymer.

A fluoropolymer dispersion, which was filled with 30% by weight of a whisker, a potassium titanate whisker here, was sprayed onto another sample with a hierarchically constructed hard base structure made of Metco 36C and Metco 130, which was applied in the above-described manner, and a microstructured first layer made of a PEA fluoropolymer powder with a 20% PPSO₂ addition applied thereto. The whiskers had a diameter in the order of magnitude of 150 to 300 nm and a length in the order of magnitude of 1 to 5 μm. The PFA dispersion had a particle size of 90 to 150 nm. The dispersion mixture was applied to the surface heated to over 100° of the sample at a high atomisation pressure with a spray gun. In this case, the water of the dispersion evaporated immediately on impact on the workpiece and the PFA particles with the whiskers were thrown on to the surface. The layer was then rigidly connected to the PEA layer located therebelow by sintering at a temperature of 350° C. for a period of 10 minutes. The desired structure is produced by the incorporated whiskers.

The whisker structure is also mechanically stable like the cluster structure. The structure cannot be removed by means of a 90° peel test with a Tesa® test adhesive tape (Tesa test tape for testing surfaces No, 07475).

The surface produced (see FIG. 4 (250 times magnification) and FIG. 4a (1000 times magnification)) has microstructures with a diameter in the range of 30 μm, which have a spacing of about 50 to 100 μm from one another and the height of which is about 20 to 70 μm. The overlaid submicro-coating has structures which are oriented using the fibres. The diameter of the fibres is about 300 to 500 nm and their length is about 1 to 5 μm. The water contact angle of the coating this produced is 175° and the run-off angle is 0°. The roughness characteristics of this surface structure are particularly high. Rₐ is about 8 μm, R_{z}=50 μm and Rₘₐₓ equals 61 μm; R_{Sk}=0.18 and R_{Ku} is 3.

In all the measurements of the water contact angle, roll-off angle end hysteresis, triple measurements were carried out. For this purpose, three uniformly distributed points were selected on a coated plate.

To measure the contact angle, water drops with a volume of 10 μl were used. A photograph of the drop on the surface was evaluated with the aid of software. The contact angle was calculated by means of the method called tangent 1 (optionally Laplace).

When the roll-off angle was determined, the coated plate had a water drop with 60 μl volume placed on it. The plate, or the entire device, was tilted until the drop began to roll off. This angle is the roll-off angle.

To determine the hysteresis, the test plate had a water drop with 60 μl volume placed on it. The plate was tilted shortly before the roll-off angle. Two different contact angles are thus formed, one on the side facing the slope and the other on the side remote therefrom. The contact angles were determined in the manner described above but the tangent 2 method was used for calculation.

To determine the Water contact angle, roll-off angle and hysteresis, the drop contour analysis system DSA 100 and the software for drop contour analysis “Drop shape analysis 3” for Windows 2000/XP version 1.50, both from the Company Krüss, Hamburg, Germany, were used.

The surface structure shown in FIG. 4b was substantially produced exactly like the surface structure shown in FIGS. 4 and 4a with the single difference that carbon tubes were added instead of potassium titanate whiskers in the same quantity to the fluoropolymer dispersion.

FIG. 5 schematically shows by way of exam a cross section of a surface coated according to the invention. A first layer of the material Metco® 36C is applied to a sandblasted substrate made of metal, which has a microstructure with elevations of about 40 μm, and a second layer of the material Metco 130 is applied thereto by flame spraying, and a primer layer is applied thereto. The two flame-sprayed layers and the primer layer form a microstructured subsurface, on which a hierarchical structure of a microstructured first layer of PEA FEP, which has PPSO₂ fillers added, and a submicrostructured second layer overlaying the latter of individual clusters of PFA/FEP are applied. In the region of the maximums of the elevations of the microstructure, the Metco 36 layer has a thickness of about 40 to 80 μm, the Metco 130 layer has a thickness of about 30 to 80 μm and the primer layer has a thickness of about 5 μm. The microstructured fluoropolymer layer of the hierarchical layer structure has a thickness of 20 to 40 μm and the clusters of the submicrostructured fluoropolymer layer have a height of about 5 μm. As can clearly be seen, the roughness of the microstructured inorganic layer is not levelled by the microstructured fluoropolymer layer. Rather, the roughness of the first microstructured inorganic layer is supplemented by the roughness of the second microstructured fluoropolymer layer. Thus, the elevations of the surface coating have a height of about 50 to 100 μm, and their maximums are spaced apart from one another by about 50 to 150 μm. The surface is additionally roughened by the clusters of the submicrostructured fluoropolymer layer.

FIG. 6 schematically shows a layer structure similar to that of FIG. 5. The layer structure differs only with regard to the submicrostructured layer, which is formed with potassium titanate whiskers instead of PFA/FEP clusters. The elevations of the surface coating have a height here of about 50 to 130 μm and their maximums are spaced apart from one another by about 50 to 150 μm. The surface is additionally roughened by the potassium titanate, whiskers or the carbon tubes of the submicrostructured layer.

A rose structure, which was produced in the example shown with a layer structure on an aluminium-based substrate, can be seen in the scanning electron microscope picture shown in FIG. 7. It can be produced, for example, by the application of a PTFE layer as the submicrostructured layer on a layer structure made of a microstructured subsurface and a first microstructured layer. The microstructured subsurface is produced by sand blasting (preferably with fine or coarse corundum) a surface made of aluminium or an aluminium alloy, whereby a microstructured substrate surface is produced. The substrate surface is anodically oxidised, so an anodic oxidation layer or preferably a hard anodic oxidation layer is produced. A subsurface with an inorganic microstructure is thus formed. Dispersions of PFA, FEP or PTFE are applied by means of a spray gun to the inorganic structure to produce the first, microstructured layer. The application of the submicrostructure and/or nanostructure is carried out in the same manner as in high-grade steel substrates. The rose structure is produced in a special time-temperature sintering cycle. PTFE is generally sintered at 380 to 400° C. for 15 minutes. In the special sintering cycle used to produce the rose structure, a significantly lower temperature is selected, preferably as in the present example of 340° C., for a significantly longer time period, preferably as in the present example of 2 hours. The elevations have a diameter of 1 to 3 μm. The height is about 500 nm to 2 μm. The spacing from one another is 2 to 10 μm. The formation of these structures can be reproduced and can be shown on various PTFE surfaces. The water contact angle is 168° with a run-off angle of 3°.

In FIGS. 8a and 8b, in each case the plan of the layer structure on an aluminium-containing substrate with a hard anodic oxidation layer is shown. The substrate surface is microstructured and has elevations with a height of about 40 μm. The hard anodic oxidation layer produced on the substrate surface is about 50 μm in thickness. Applied to the hard anodic oxidation layer is a primer layer with a thickness of about 2 μm, on which a fluoropolymer layer with a thickness of about 5 μm is arranged. The microstructure of the fluoropolymer layer corresponds here approximately to the microstructure of the metal substrate.

The surface coatings shown in FIGS. 8a and 8b differ by the submicrostructured layer which is applied to the microstructured fluoropolymer layer and which is formed in FIG. 8a by PFA or FEP clusters with a height of about 5 μm, while the surface in FIG. 8b is additionally structured by whiskers with a length of about 5 μm and a diameter of about 150 to 300 nm. Alternatively, the surface can also be submicrostructured with a rose structure described with reference to FIG. 7.

1. Non-stick coating for a surface of a substrate, which contains at least one non-adhesive plastics material, in particular at least one fluoropolymer, characterised by a hierarchical layer structure with at least one microstructured first layer and at least one submicrostructured second layer overlaying the latter, the hierarchical structure being applied to a microstructured subsurface.

2. Non-stick coating according to any one of the preceding claims, characterised in that the first layer contains an addition of 5 to 30% by weight of organic or inorganic particles, in particular of PPSO₂ or SiC.

3. Non-stick coating according to any one of the preceding claims, with a water contact angle CA>=150°, in particular in conjunction with a water contact angle hysteresis CAH<=8° and/or a run-off angle <=10°.

4. Non-stick coating according to any one of the preceding claims, with an adhesive tape removal force approaching 0.

5. Method for producing a non-stick coating, wherein a first microstructured layer is applied to a microstructured subsurface and a submicrostructured layer is applied thereto.

6. Method according to claim 5, characterised in that the microstructured subsurface is produced by the application of a microstructured layer to a macrostructured surface.

7. Method according to claim 6, characterised in that the substrate surface is sand blasted to produce the macrostructured surface.

8. Method according to claim 6 or 7, characterised in that to produce the macrostructured surface, a macrostructured layer is applied to the substrate, in particular by flame spraying a metal wire or metal powder, in particular of chromium/nickel wire or of melted chromium/nickel powder.

9. Method according to any one of claims 6 to 8, characterised in that the microstructured layer is produced by application of oxide ceramics, in particular TiO₂ and/or Al₂O₃, into the macrostructured surface, preferably by thermal spraying.

10. Method according to any one of claims 5 to 9, characterised in that at least a first layer, in particular a powder containing at least one fluoropolymer with a grain size in the range of 500 nm to 30 μm, is applied to the microstructured subsurface.

11. Method according to claim 10, characterised in that the powder contains an admixture of organic or inorganic particles, in particular of SiC, Al₂SO₃ and/or PPSO₂, preferably at a fraction of 5 to 30% by weight.

12. Method according to claim 10 or 11, characterised in that a second layer in the form of a finely dispersed fluoropolymer with a grain size of 90 to 300 nm is applied to the first layer.

13. Method according to claim 12, characterised in that the coating is heated in such a way that the particles of the second layer merely start to melt, so they connect to the layer located therebelow but substantially retain their shape.

14. Method according to claim 12 or 13, characterised in that the finely dispersed fluoropolymer contains an addition of whiskers, in particular of potassium titanate whiskers, preferably at a fraction of 10 to 40% by weight.

15. Method according to any one of cairns 5 to 14, characterised in that before the application of the layer structure, a primer layer is applied to the microstructured subsurface, the thickness of which does not exceed 5 μm, in particular 1 μm.
